(19) United States
(12) Patent Application Publication
(10) Pub. No.: US 2015/0143062 A1
(43) Pub. Date: May 21, 2015

(54) CONTROLLER, STORAGE DEVICE, AND CONTROL METHOD

(71) Applicant: KABUSHIKI KAISHA TOSHIBA, Minato-ku (JP)

(72) Inventors: Norifumi TSUBOI, Yokohama-shi (JP); Jun ICHISHIMA, Yokohama-shi (JP)

(73) Assignee: KABUSHIKI KAISHA TOSHIBA, Minato-ku (JP)

(21) Appl. No.: 14/206,325

(22) Filed: Mar. 12, 2014

(30) Foreign Application Priority Data
Nov. 20, 2013 (JP) 2013-240313

(51) Int. Cl. G06F 3/06

(52) U.S. Cl. CPC G06F 3/0658; G06F 3/0604; G06F 3/0671; G06F 2003/0697
USPC 711/154

(57) ABSTRACT

A controller of an embodiment includes: an interface unit configured to be connected to a storage unit and configured to execute a command performing one or more basic operations for the storage unit in a predetermined order; and a control unit configured to hold, for each category to which the basic operations belong, a control procedure of a signal between the interface unit and the storage unit during execution of the basic operations which belong to the category. The control unit is configured to obtain the basic operations constituting the command executed by the interface unit based on first information indicating the basic operations constituting the command and an order of execution of the basic operations, and to cause the interface unit to execute the obtained basic operations based on second information indicating the category to which the basic operations belong in the order indicated in the first information.

### CROSS-REFERENCE TO RELATED APPLICATIONS

This application is based upon and claims the benefit of priority from Japanese Patent Application No. 2013-240313, filed on Nov. 20, 2013; the entire contents of which are incorporated herein by reference.

### FIELD

Embodiments described herein relate to a controller, a storage device, and a control method.

### BACKGROUND

A NAND type flash memory has different chip configurations depending on the generation of the memory. Depending on the chip configurations, there are differences in, for example, a recording method (SLC, MLC, TLC, or the like), an array configuration (four planes, two planes, one plane, or the like), and a page size (8 KB, 16 KB, or the like). Further, depending on the chip configurations, an interface protocol varies. For the reasons described above, a controller LSI corresponding to a NAND type flash memory with a specific chip configuration cannot control a NAND type flash memory with a different chip configuration. Therefore, in the development of a storage device using a NAND type flash memory, there is demand for a controller which can flexibly cope with a change in a chip configuration of the NAND type flash memory. There is such demand also with respect to interface protocols such as wireless communication and a LAN, as well as an interface for the NAND type flash memory.

### BRIEF DESCRIPTION OF THE DRAWINGS

FIG. 1 is a block diagram illustrating a configuration of a storage device according to the present embodiment;

FIG. 2 is a diagram illustrating a configuration of an information holding unit according to the present embodiment;

FIG. 3 is a diagram illustrating changes of interface signals over time in a command issue cycle of the present embodiment;

FIG. 4 is a diagram illustrating changes of the interface signals over time in an address issue cycle of the present embodiment;

FIG. 5 is a diagram illustrating changes of the interface signals over time in a data write cycle of the present embodiment;

FIG. 6 is a diagram illustrating changes of the interface signals over time in a data read cycle of the present embodiment;

FIG. 7 is a diagram illustrating a configuration of a first table (an ID0 table) of the present embodiment;

FIG. 8 is a diagram illustrating a configuration of a second table (an ID1 table) of the present embodiment;

FIG. 9 is a diagram illustrating a configuration of a third table (an ID2 table) of the present embodiment;

FIG. 10 is a diagram illustrating a configuration of a fourth table (an ID3 table) of the present embodiment;

FIGS. 11A to 11C are correspondence tables for obtaining a block address and a page address from a page counter in different array configurations of the present embodiment;

FIG. 12 is a flow chart illustrating operations of a controller from setting a configuration of a NAND chip to issuing a NAND command in the present embodiment; and

FIGS. 13A to 13D are time charts illustrating operation orders of basic operations of the NAND command of the present embodiment.

### DETAILED DESCRIPTION

A controller according to one embodiment of the present invention includes: an interface unit configured to be connected to a storage unit and configured to execute a command performing one or more basic operations for the storage unit in a predetermined order; and a control unit configured to hold, for each category to which the basic operations belong, a control procedure of a signal between the interface unit and the storage unit during execution of the basic operations which belong to the category. The control unit is configured to obtain the basic operations constituting the command executed by the interface unit based on first information indicating the basic operations constituting the command and an order of execution of the basic operations, and to cause the interface unit to execute the obtained basic operations based on second information indicating the category to which the basic operations belong in the order indicated in the first information.

Hereinbelow, a controller, a storage device, and a control method according to an embodiment are described in detail with reference to the accompanying drawings. It should be noted that the present invention is not limited to the embodiment.

### Embodiment

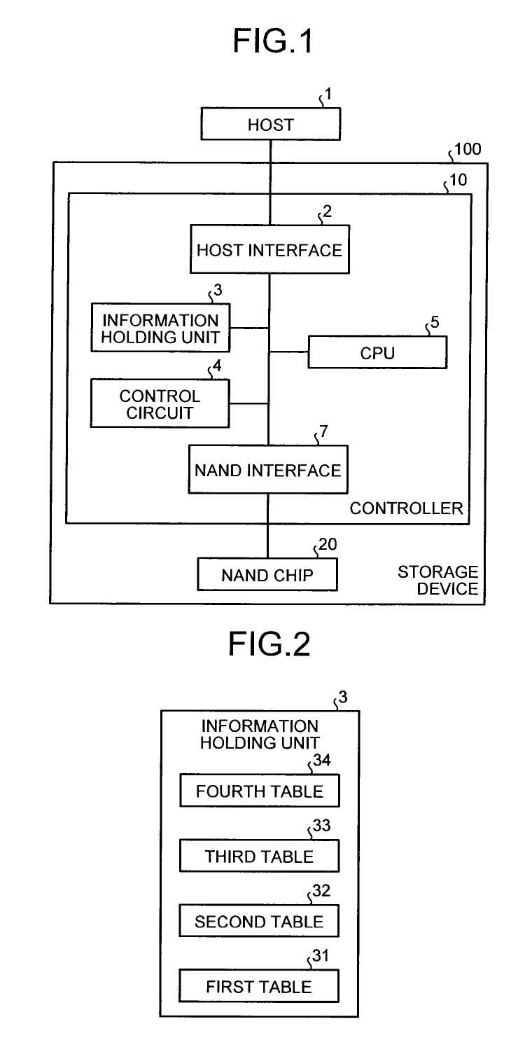

FIG. 1 is a block diagram illustrating a configuration of a storage device 100 according to the present embodiment. The storage device 100 includes a NAND chip 20 as a nonvolatile memory and a controller 10 configured to control the NAND chip 20. The controller 10 includes a CPU 5, a host interface 2, a NAND interface 7, an information holding unit 3, and a control circuit 4 including a logic circuit. The controller 10 is coupled to a host 1 such as a PC via the host interface 2 and to the NAND chip 20 via the NAND interface 7. The information holding unit 3 includes, as illustrated in FIG. 2, a first table 31, a second table 32, a third table 33, and a fourth table 34, which will be described later.

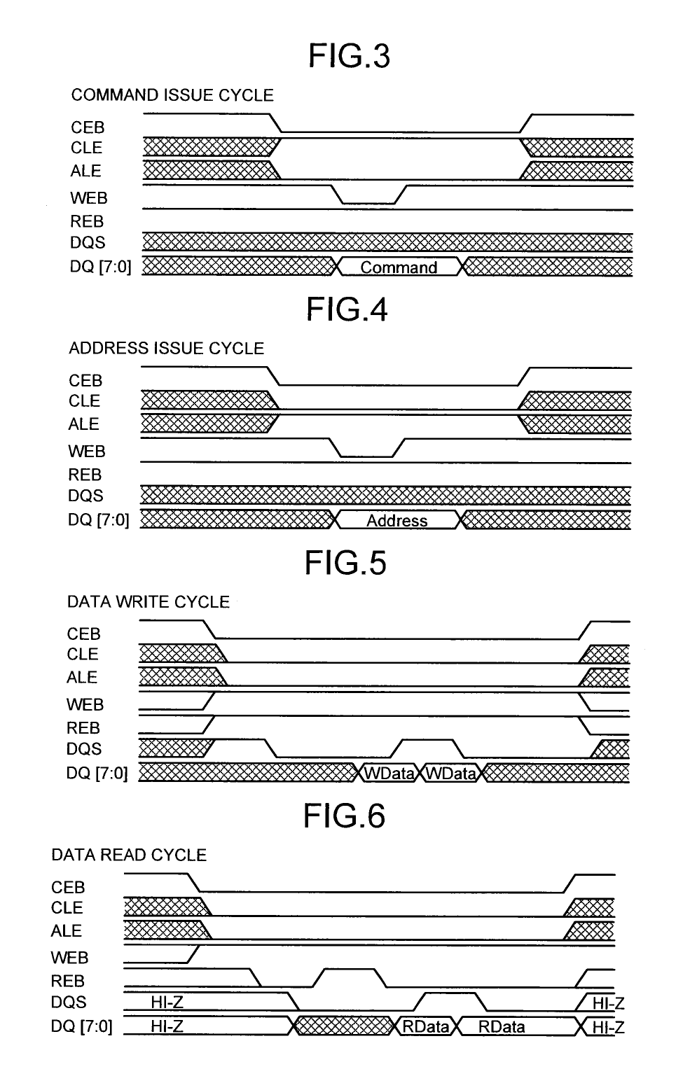

Primitives are basic configurations of an interface protocol in the NAND interface 7, and correspond to basic operations of the NAND interface 7. These primitives are defined by an interface specification “Toggle DDR (Double Data Rate) 2.0”, for example. The basic operations of the NAND interface 7 can be classified into a plurality of categories depending on differences in a control procedure of a plurality of interface signals described below. For example, when each category is called a cycle, the basic operations of the NAND interface 7 can be classified into five categories, that is, a command issue cycle (FIG. 3), an address issue cycle (FIG. 4), a data write cycle (FIG. 5), a data read cycle (FIG. 6), and an NOP cycle. The NOP cycle is a cycle which instructs a delay, and thus not illustrated. FIGS. 3 to 6 illustrate changes of the interface signals (for example, a chip enable (CEB) signal instructing an active chip, a command latch enable (CLE) signal latching a command signal, an address latch enable (ALE) signal latching an address signal, a write enable (WEB) signal enabling writing, a read enable (REB) signal enabling reading, a data strobe signal (DQS) being a synchronization signal of a data signal, and the data signal (DQ) indicating data) over time, the interface signals being control signals between the NAND interface 7 and the NAND chip 20, in operation states of each category. The data strobe signal (DQS) and the data signal (DQ) are bidirectional signals, and the other signals are the control signals from the NAND interface 7 to the NAND chip 20. It should be noted that DQ [7:0] indicates that the data signal is 8 bits.

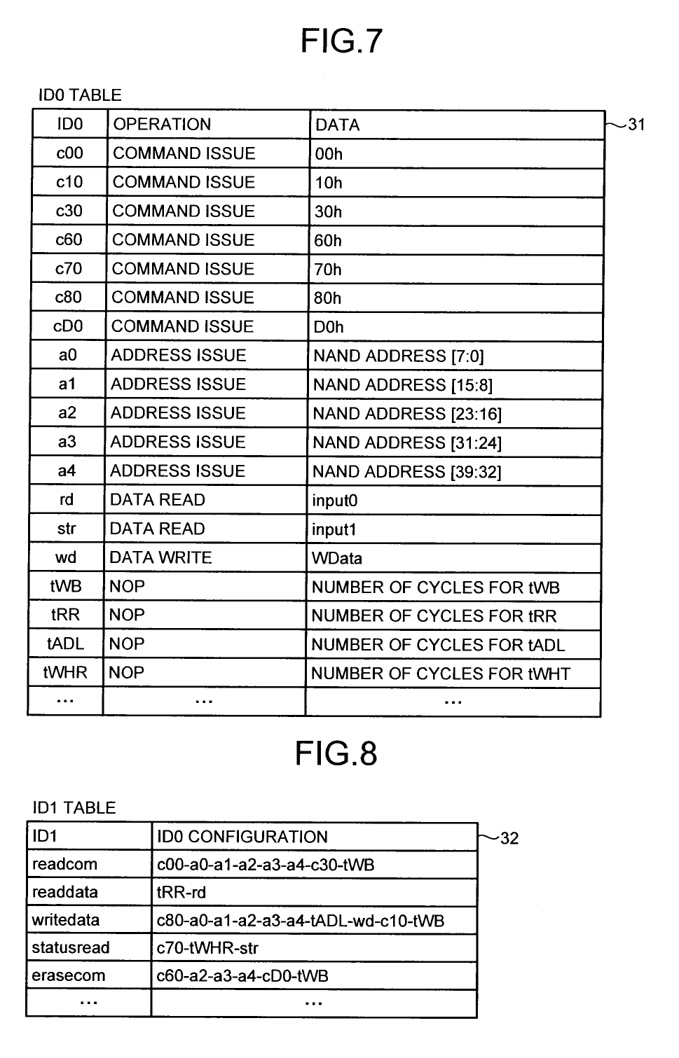

Further, the basic operations which belong to each cycle can be subdivided so as to correspond to the primitives. The first table 31 (an ID0 table) in FIG. 7 illustrates cycles and data of the basic operations for each of “ID0” which are IDs corresponding to the primitives. In the first table 31, “ID0” indicates IDs corresponding to each of the primitives, “operation” indicates cycles, and “data” indicates contents of the data signal (DQ).

For example, the command issue cycle can be classified into levels of the basic operations corresponding to the primitives, such as [80h command] and [00h command]. The basic operations of the command issue cycle include, for example, a mode in which the data signal (DQ) is directly designated. When the designated data signal (DQ) is [80h command], each of the interface signals is operated so that the command becomes 80h in the data signal (DQ) in the command issue cycle illustrated in FIG. 3. That is, when “ID0” is “c80”, the interface signal is uniquely determined as CEB=0, CLE=1 (enable state), ALE=0, WEB=strobe operation (an operation in which a signal once decreases from 1 to 0 and thereafter increases from 0 to 1), REB=1 (non-use state), DQS=non-drive state (undefined value), and DQ=80h. It should be noted that hatched parts of each of the signals illustrated in FIGS. 3 to 6 indicate undefined values <0 or 1>.

The basic operations of the address issue cycle illustrated in FIG. 4 include a mode in which an address is directly designated by the data signal (DQ) and a NAND address mode in which a NAND address greater than 8 bits is designated. In the NAND address mode usually used, for example, when a storage area of the NAND chip 20 is designated by a 40-bit address, addresses corresponding to 40 bits are generated by the control circuit 4, and 8 bits in the 40 bits ([7:0], [15:8], [23:16], [31:24], and [39:32]) are registered in the table in FIG. 7 as “a0”, “a1”, “a2”, “a3”, and “a4”. When “ID0” is “a0”, the interface signal is uniquely determined as CEB=0, CLE=0, ALE=1 (enable state), WEB=strobe operation, REB=1, DQS=non-drive state (undefined value), DQ=NAND ADDRESS [7:0].

The basic operations of the data write cycle illustrated in FIG. 5 include a mode in which the data signal (DQ) can be directly designated and a data transfer mode. In the data transfer mode usually used, by setting data from the host 1 as the data signal (DQ), the data can be transferred to the NAND chip 20. In the case of the data transfer mode in data write, that is, when “ID0” is “wd”, the interface signal is uniquely determined as CEB=0, CLE=0, ALE=0, WEB=1, REB=1, DQS=toggle state, and DQ=WData. The toggle state is a state in which the signal changes from 0 to 1, and thereafter from 1 to 0. In FIG. 5, by the toggle of the data strobe signal (DQS), a WData value which is a DQ value when DQS changes from 0 to 1 and a WData value which is a DQ value when DQS changes from 1 to 0 are transferred to the NAND chip 20. FIG. 5 illustrates transfer of data of 8 bits×2. When the number of toggles is increased, data of 8 bits×2×(number of toggles) can be transferred.

The basic operations of the data read cycle illustrated in FIG. 6 include a register mode in which data from the NAND chip 20 is held by a register, and a data transfer mode. In the data transfer mode usually used, read data from the NAND chip 20 is controlled to be transferred to the host 1. In the case of the data transfer mode in data read, that is, when “ID0” is “rd”, the interface signal is uniquely determined as CEB=0, CLE=0, ALE=0, WEB=1, REB=toggle state, DQS=Hi-Z, and DQ=Hi-Z. In this case, DQS and DQ are input signals from the NAND chip 20. In FIG. 6, DQS becomes the toggle state in accordance with the toggle of REB, and by the toggle of DQS, an RData value which is a DQ value when DQS changes from 0 to 1 and an RData value which is a DQ value when DQS changes from 1 to 0 are received as data. FIG. 6 illustrates transfer of data of 8 bits×2. When the number of toggles is increased, data of 8 bits×2×(number of toggles) can be transferred. A mode in which data from the NAND chip 20 is held by the register includes status read which notifies the CPU 5 of a state of the NAND chip 20. The primitive of the status read is indicated by “str” in the column “ID0” in FIG. 7.

In the case of the basic operations of the NOP cycle, the NAND interface 7 is controlled so as not to be operated for a time corresponding to a designated number of operation cycles. In the case of the NOP cycle in which “ID0” is “tRR”, the number of cycles which can be ensured for the time tRR is set. During a period of the NOP cycle, the NAND interface 7 is controlled to hold the previous state of each of the interface signals.

The above-described control procedures of the interface signals for each category illustrated in FIGS. 3 to 6 are held in the control circuit 4. The control circuit 4 can cause the NAND interface 7 to execute each of the primitives based on information on ID0 (a first label) as a primitive ID and the first table 31 (the ID0 table).

When the ID (“ID0”) is confirmed in this way and the primitive is specified, the operation of the control signal of the NAND interface 7 can be uniquely determined. The ID for the primitive can be set as an ID which is unique in all categories, as illustrated in FIG. 7. Thus, for example, “a0”, “a1”, “a2”, “a3”, and “a4” may be combined into one as a primitive which belongs to a category of the address issue cycle, so that addresses for 5 bytes may be issued as one primitive, an ID may be assigned to the primitive, and the ID may be registered in the first table 31 in FIG. 7.

Further, a table is created in which IDs (“ID1”) (a second label) are attached to assemblies of a smallest unit of primitive IDs (“ID0”), the primitive IDs corresponding to the basic operations which can be continuously executed and being aligned in the assemblies in an operation order. The table is illustrated as the second table 32 (an ID1 table) in FIG. 8. The assemblies are defined to issue a command in a format in accordance with a protocol of the NAND interface 7. In the column of “ID0 configuration” in the second table 32 (the ID1 table) in FIG. 8, the primitive IDs (“ID0”) corresponding to the basic operations which can be continuously executed are illustrated in an operation order. Examples of the smallest unit include from a basic operation executed first to a basic operation executed by the timing when a READY/BUSY signal indicating an operation state of the NAND chip 20 becomes a BUSY state (“0”). Therefore, the READY/BUSY signal is in a READY state (“1”) at least during the smallest unit. The READY/BUSY signal is also one of the interface signals which are the control signals between the NAND interface 7 and the NAND chip 20.

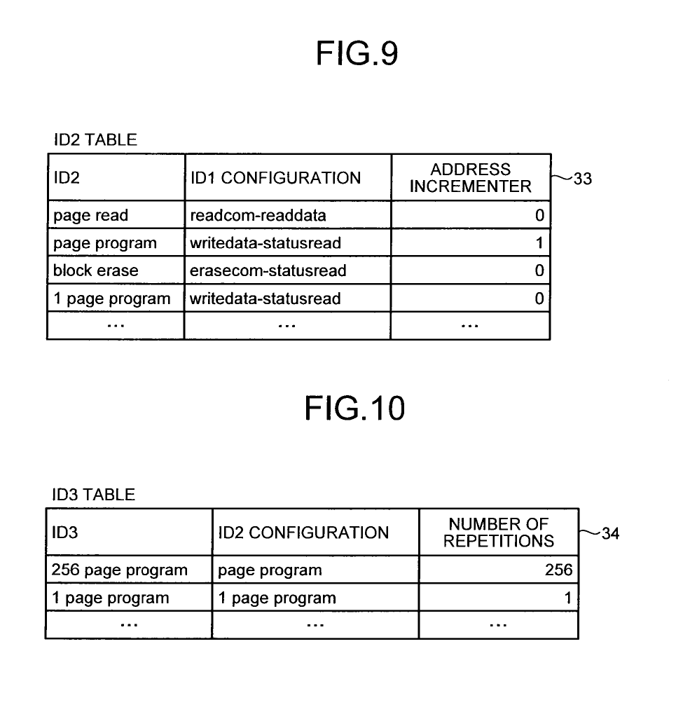

Further, a table is created in which the assemblies (“ID1”) illustrated in FIG. 8 are aligned in an operation order in the command (“ID2”) in a format in accordance with a protocol (for example, “Toggle DDR 2.0”) of the NAND interface 7 in order to achieve the command. This table is illustrated as the third table 33 (an ID2 table) in FIG. 9. In the column of “ID1 configuration” in the third table 33 (the ID2 table) in FIG. 9, orders of execution of “ID1” are illustrated. The first table 31 to the third table 33 are set in the information holding unit 3 by the CPU 5 configured to execute firmware. From the first table 31 to the third table 33, the control circuit 4 can acknowledge the basic operations constituting the command, the order of execution of the basic operations (first information) and categories of the basic operations (second information). Accordingly, the command in the format in accordance with the protocol of the NAND interface 7 can be generated.

As described in the above example, the “Toggle DDR 2.0” can be executed as the interface protocol of the NAND interface 7 also by creating the three classes of the tables, i.e. the first table 31 to the third table 33 as illustrated in FIGS. 7 to 9. Further, by employing such a table configuration, a new primitive can be added only by changing the first table 31 in FIG. 7. Further, the above-described smallest unit using the added new primitive or the command using the smallest unit can be easily created by changing the table.

Further, it is also possible to determine operation orders corresponding to a plurality of “ID2” and execute the operations, or to define repeated execution of the operations corresponding to “ID2” as a superior command. FIG. 10 is a table defining the superior command. FIG. 10 illustrates “ID2 configuration” and “number of repetitions” corresponding to IDs (“ID3”) (a third label) indicating the superior commands. By setting the table as the fourth table 34 (an ID3 table), the superior command such as a 256 page program (to repeat 1 page program 256 times) can be defined with an instruction set designated by “ID3”, and the superior command can be executed.

In the interface protocol of the NAND interface 7, it is necessary to designate an address of the NAND chip 20. However, by adding information on “address incrementer” of a page address to the third table 33 (the ID2 table) in FIG. 9, the address of the NAND chip 20 to be accessed can be created easily. The “address incrementer” indicates, for the command executed repeatedly, an increased amount of the page address of the NAND chip 20 to be executed during execution of the next identical command.

Hereinbelow, a process in the address issue cycle is explained as an example. As information on “ID2” table, an operation mode in which a page counter (an address counter) is incremented by one is added. Specifically, when “ID2” is “page program”, “1” is described in the column of “address incrementer”. The control circuit 4 includes the page counter, making it possible to access the NAND chip 20 using a sequential page address from a start address.

At this stage, however, the NAND chip 20 in which the number of planes operable in parallel is different is not supported, for example. This is because, in the case where there is a plurality of planes, block addresses of blocks as erasure units of the NAND chip 20 are numbered across different planes, and when the addresses are incremented, it is necessary to designate a block address and a page address.

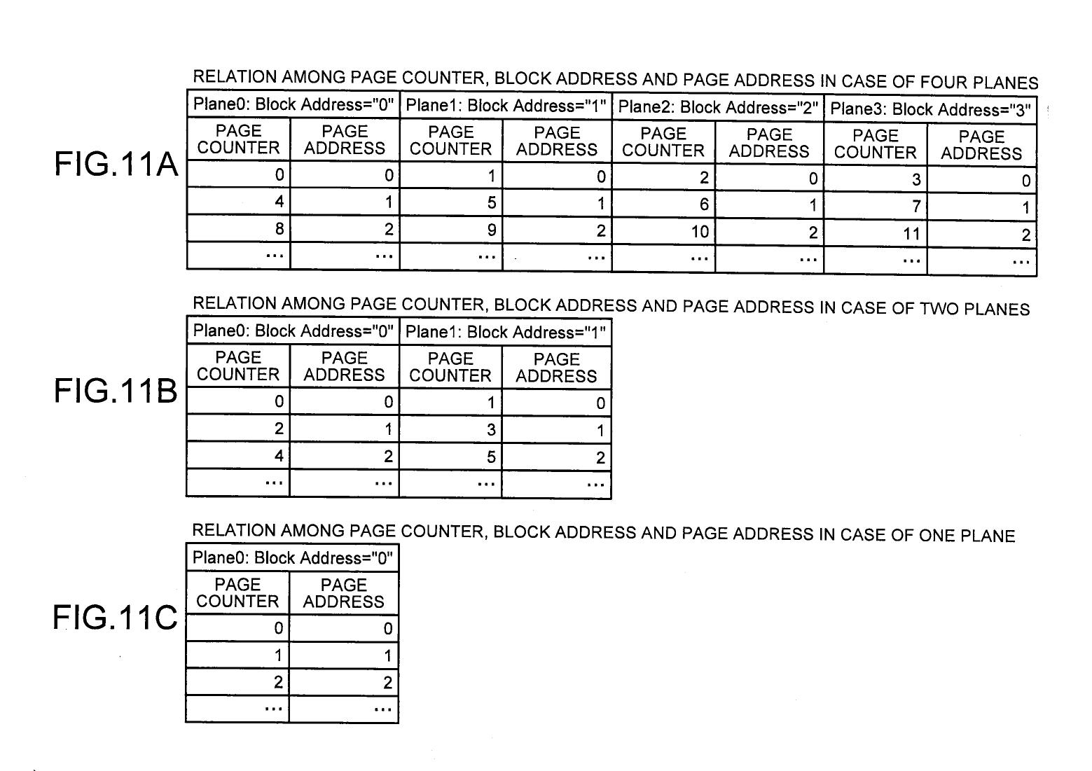

A function to calculate a block address and a page address from a page counter is therefore added to the control circuit 4. This configuration is determined in accordance with a configuration of the plane of the NAND chip 20 to be coupled. FIGS. 11A to 11C illustrate examples of a correspondence table for obtaining the block address and the page address from the page counter, depending on the configuration of the plane. In the tables, the page address indicates an address in a block in each of the planes. FIGS. 11A to 11C illustrate correspondence tables in the case of four planes, two planes and one plane, respectively. This function enables execution of a designated number of pages of the page program for various generations of the NAND chip 20.

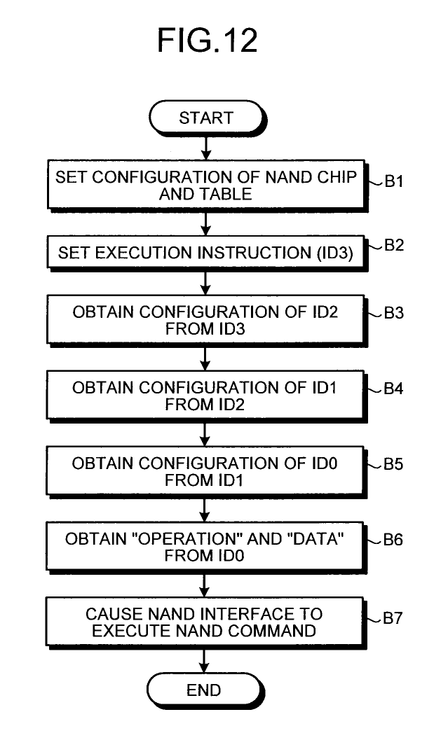

Hereinbelow, using a flow chart illustrated in FIG. 12, an operation is described from setting a configuration of the NAND chip 20 in the controller 10 to issuing a NAND command to the NAND chip 20.

First, the CPU 5 configured to execute the firmware sets the configuration of the NAND chip 20 in the control circuit 4, and the first to fourth tables in the information holding unit 3 (block B1). Specifically, a recording method (SLC, MLC, TLC, or the like) of the NAND chip 20 to be coupled to the controller 10, the number of the planes, and the like are set in the control circuit 4. Next, the CPU 5 sets an execution instruction (command) for the NAND chip 20 in the control circuit 4 (block B2). The execution instruction (command) set here is the one designated by the above-described “ID3”, for example.

Next, the control circuit 4 assumes that the execution instruction set in block B2 is “ID3”, refers to the fourth table 34 (the ID3 table) (FIG. 10) held in the information holding unit 3, and returns “ID2 configuration” and “number of repetitions” corresponding to “ID3” to the control circuit 4 (block B3). For example, when “ID3” is “256 page program”, “page program” and 256 as “number of repetitions” can be obtained.

Next, for each “ID2” constituting “ID2 configuration” obtained in block B3, the control circuit 4 refers to the third table 33 (the ID2 table) (FIG. 9) held by the information holding unit 3 and obtains “ID1 configuration” corresponding to “ID2” (block B4). At this time, as described above, it is also possible to obtain a value of “address incrementer” and increment the page counter.

Next, for each “ID1” constituting “ID1 configuration” obtained in block B4, the control circuit 4 refers to the second table 32 (the ID1 table) (FIG. 8) held by the information holding unit 3 and obtains “ID0 configuration” corresponding to “ID1” (block B5).

Next, for each of the primitives indicated by “ID0” constituting “ID0 configuration” obtained in block B5, the control circuit 4 refers to the first table 31 (the ID0 table) held by the information holding unit 3 and obtains “operation” and “data” corresponding to the primitives (block B6).

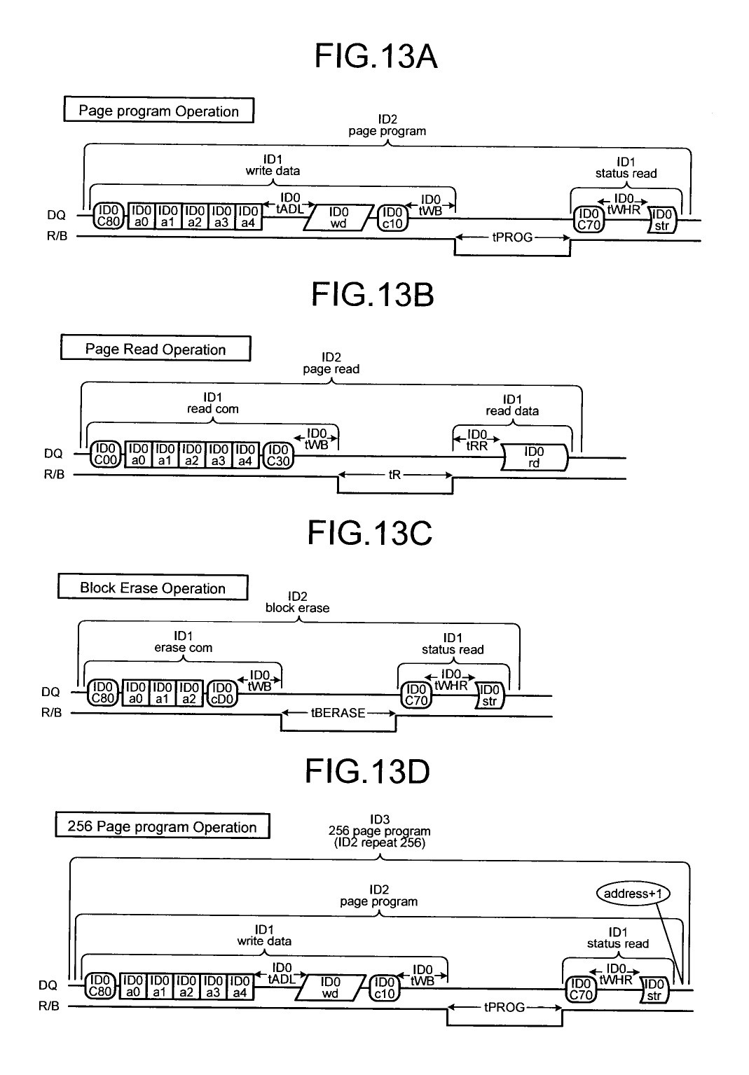

By the above blocks B3 to B6, the control circuit 4 can grasp the configurations of the primitives of the NAND command as illustrated in FIGS. 13A to 13D. Therefore, the control circuit 4 can execute the NAND command corresponding to the configuration of the NAND chip 20, in accordance with the protocol of the NAND interface 7. FIGS. 13A to 13D are time charts of operations of the primitives of “Page Program Operation”, “Page Read Operation”, “Block Erase Operation”, and “256 Page Program Operation”, respectively. When information as illustrated in FIGS. 13A to 13D is provided by the control circuit 4, the NAND interface 7 executes the NAND command for the NAND chip 20 (block B7). Each of the primitives illustrated in FIGS. 13A to 13D is executed by the NAND interface 7 for the NAND chip 20 as the interface signals illustrated in FIGS. 3 to 6.

According to the controller, the storage device, and the control method for the storage device of the present embodiment, the controller includes information indicating a relation between the command in the format in accordance with a given interface protocol and the primitive. Specifically, a relation between the NAND command and the primitive is represented by at least three stages of tables having a hierarchical structure, and the tables are sequentially drawn for a given command. Accordingly, an assembly of the primitives can be obtained in accordance with the NAND interface protocol corresponding to the command such as one page program, one page read, one block erase, and 256 page program as a superordinate concept. With this configuration, a command can be issued finally to the NAND chip 20.

In other words, only by changing the firmware rewriting the three stages of the tables, it is also possible to add a new primitive, to correspond to various generations of the NAND interface protocol without changing the hardware, and to control various generations of the NAND chip.

In the above-described embodiment, the NAND interface has been described as an example of the interface protocol applied to the hardware. However, the embodiment is not limited to the above example. Any command interface such as for wireless communication and a LAN can also be applied as long as the protocol is defined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A controller, comprising:
an interface unit configured to be connected to a storage unit and configured to execute a command performing one or more basic operations for the storage unit in a predetermined order; and
a control unit configured to hold, for each category to which the basic operations belong, a control procedure of a signal between the interface unit and the storage unit during execution of the basic operations which belong to the category,
wherein the control unit is configured to obtain the basic operations constituting the command executed by the interface unit based on first information indicating the basic operations constituting the command and an order of execution of the basic operations, and to cause the interface unit to execute the obtained basic operations based on second information indicating the category to which the basic operations belong in the order indicated in the first information.

2. The controller according to claim 1,
wherein the control unit is configured to cause an information holding unit to hold tables corresponding to the first and second information.

3. The controller according to claim 1,
wherein the first and second information include:
a first table indicating correspondence between a first label and the category, the first label being a label of the basic operations;
a second table indicating correspondence between a second label and an assembly in which the basic operations which are continuously executable are aligned in an operation order, the second label being a label of the assembly; and
a third table indicating correspondence between the command and the second label of the assembly constituting the command.

4. The controller according to claim 2,
wherein the first and second information include:
a first table indicating correspondence between a first label and the category, the first label being a label of the basic operations;
a second table indicating correspondence between a second label and an assembly in which the basic operations which are continuously executable are aligned in an operation order, the second label being a label of the assembly; and
a third table indicating correspondence between the command and the second label of the assembly constituting the command.

5. The controller according to claim 3, further holding a fourth table that describes correspondence among a third label, the command and the number of repetitions of the command, the third label being a label of a upper command executing the command a plurality of times.

6. The controller according to claim 4, further holding a fourth table that describes correspondence among a third label, the command and the number of repetitions of the command, the third label being a label of a upper command executing the command a plurality of times.

7. The controller according to claim 3,
when the storage unit includes a plurality of planes configured to be operable in parallel, wherein
the third table is configured to hold an increased value of an address in the storage unit for every repetition of the command,
the control unit is configured to hold an address counter for adding the increased value for every repetition of the command, and to hold information indicating correspondence among a value of the address counter, the planes and the address in the planes.

8. A storage device, comprising:
a storage unit; and
a controller connected to the storage unit,
wherein the controller includes:
an interface unit configured to be connected to the storage unit and configured to execute a command performing one or more basic operations for the storage unit in a predetermined order; and
a control unit configured to hold, for each category to which the basic operations belong, a control procedure of a signal between the interface unit and the storage unit during execution of the basic operations which belong to the category, wherein
the control unit is configured to obtain the basic operations constituting the command executed by the interface unit based on first information indicating the basic operations constituting the command and an order of execution of the basic operations, and to cause the interface unit to execute the obtained basic operations based on second information indicating the category to which the basic operations belong in the order indicated in the first information.

9. The storage device according to claim 8,
wherein the control unit is configured to cause an information holding unit to hold tables corresponding to the first and second information.

10. The storage device according to claim 8,
wherein the first and second information include:
a first table indicating correspondence between a first label and the category, the first label being a label of the basic operations;
a second table indicating correspondence between a second label and an assembly in which the basic operations which are continuously executable are aligned in an operation order, the second label being a label of the assembly; and
a third table indicating correspondence between the command and the second label of the assembly constituting the command.

11. The storage device according to claim 9,
wherein the first and second information include:
a first table indicating correspondence between a first label and the category, the first label being a label of the basic operations;
a second table indicating correspondence between a second label and an assembly in which the basic operations which are continuously executable are aligned in an operation order, the second label being a label of the assembly; and
a third table indicating correspondence between the command and the second label of the assembly constituting the command.

12. The storage device according to claim 10, further holding a fourth table that describes correspondence among a third label, the command and the number of repetitions of the command, the third label being a label of a upper command executing the command a plurality of times.

13. The storage device according to claim 11, further holding a fourth table that describes correspondence among a third label, the command and the number of repetitions of the command, the third label being a label of a upper command executing the command a plurality of times.

14. The storage device according to claim 10,
when the storage unit includes a plurality of planes configured to be operable in parallel, wherein
the third table is configured to hold an increased value of an address in the storage unit for every repetition of the command,
the control unit is configured to hold an address counter for adding the increased value for every repetition of the command, and to hold information indicating correspondence among a value of the address counter, the planes and the address in the planes.

15. A control method of controlling a storage unit in a storage device via an interface unit configured to execute a command performing one or more basic operations in a predetermined order, the method comprising:
holding, for each category to which the basic operations belong, a control procedure of a signal between the interface unit and the storage unit during execution of the basic operations which belong to the category;
obtaining the basic operations constituting the command executed by the interface unit based on first information indicating the basic operations constituting the command and an order of execution of the basic operations; and
causing the interface unit to execute the obtained basic operations based on second information indicating the category to which the basic operations belong in the order indicated in the first information.

16. The control method according to claim 15,
wherein tables corresponding to the first and second information is held.

17. The control method according to claim 15,
wherein the first and second information include:
a first table indicating correspondence between a first label and the category, the first label being a label of the basic operations;
a second table indicating correspondence between a second label and an assembly in which the basic operations which are continuously executable are aligned in an operation order, the second label being a label of the assembly; and
a third table indicating correspondence between the command and the second label of the assembly constituting the command.

18. The control method according to claim 16,
wherein the first and second information include:
a first table indicating correspondence between a first label and the category, the first label being a label of the basic operations;
a second table indicating correspondence between a second label and an assembly in which the basic operations which are continuously executable are aligned in an operation order, the second label being a label of the assembly; and
a third table indicating correspondence between the command and the second label of the assembly constituting the command.

19. The control method according to claim 17, further comprising:
holding a fourth table that describes correspondence among a third label, the command and the number of repetitions of the command, the third label being a label of a upper command executing the command a plurality of times.

20. The control method according to claim 17, when the storage unit includes a plurality of planes configured to be operable in parallel, the method further comprising:
holding an increased value of an address in the storage unit for every repetition of the command;
holding an address counter for adding the increased value for every repetition of the command; and
holding information indicating correspondence among a value of the address counter, the planes and the address in the planes.
